(19) United States
(12) Patent Application Publication
(10) Pub. No.: US 2010/0036600 A1
(43) Pub. Date: Feb. 11, 2010

(54) PORTABLE DEVICE AND ELECTRONIC DEVICE SYSTEM

(75) Inventors: Takashi SHINMYOH, Kobe-shi (JP); Ichiro ENOMOTO, Kawasaki-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/537,739

(22) Filed: Aug. 7, 2009

(30) Foreign Application Priority Data
Aug. 7, 2008 (JP) 2008-204733

(51) Int. Cl. G05B 13/02; G01C 21/00

(52) U.S. Cl. 701/200; 700/40

(57) ABSTRACT

A portable device is mountable on an in-vehicle device. The portable device has a plurality of modes. A control unit is configured to automatically select one mode from among the modes when the portable device is mounted on the in-vehicle device. The one mode to be automatically selected by the control unit is user-presettable.

The disclosure of Japanese Patent Application No. 2008-204733 filed on Aug. 7, 2008 including specification, drawings and claims is incorporated herein by reference in its entirety.

### BACKGROUND

The present invention relates to a portable device which is mountable on an in-vehicle device, and an electronic device system including the portable device and the in-vehicle device.

A related-art navigation device includes an in-vehicle navigation device for performing a route guide to a destination set by a user. Such an in-vehicle navigation device can be portable.

Patent Documents 1 and 2 disclose a navigation unit which is attachable to and detachable from an in-vehicle device. When the navigation unit is detached from the in-vehicle device, the navigation unit can be used as a single unit portable navigation device.

Patent Document 3 discloses a navigation device which can be mounted on a vehicle and can be detached from the vehicle to allow the navigation device to be used when walking. When the navigation device is connected to the vehicle, the navigation device is in a car navigation mode (vehicle-mounted navigation mode). When the navigation device is detached from the vehicle, the navigation device is in a human navigation mode (walking navigation mode).

Patent Document 1: Japanese Patent Publication No. 08-318792 A

Patent Document 2: Japanese Patent Publication No. 2005-524570 A

Patent Document 3: Japanese Patent Publication No. 2003-166848 A

However, in the Patent Document 3, the navigation device is automatically and forcibly set to the car navigation mode when the navigation device is connected to the in-vehicle device and the navigation device is automatically and forcibly set to the human navigation mode when the navigation device is detached from the in-vehicle device. That is, the navigation device is automatically set to the specific mode irrespective of intention of the user.

In a case where a portable car navigation device has an audio mode and a navigation mode and the device is set to the audio mode before being connected to the in-vehicle device, for example, the device may be automatically changed to the car navigation mode after being connected to the in-vehicle device even when the user wants to continue the audio mode. In this case, the user needs to set the device to the audio mode again.

### SUMMARY

It is therefore an object of at least one embodiment of the present invention to provide a portable device or an electronic device which is capable of automatically selecting a user-desired mode when a portable device is mounted on an in-vehicle device.

According to a first aspect of at least one embodiment of the present invention, there is provided a portable device which is mountable on an in-vehicle device, wherein the portable device has a plurality of modes; wherein the portable device includes a control unit which is configured to automatically select one mode from among the modes when the portable device is mounted on the in-vehicle device; and wherein the one mode to be automatically selected by the control unit is user-presettable.

The portable device may further include an acquiring unit which is configured to acquire information from the in-vehicle device, and the one mode to be automatically selected by the control unit may be determined based on the information acquired by the acquiring unit. The one mode to be automatically selected by the control unit may be determined by a combination of a mode of the portable device, which has been selected before the portable device is mounted on the in-vehicle device and the information acquired by the acquiring unit.

The portable device may further include a display unit and an operation unit, and the one mode to be automatically selected by the control unit may be user-presettable by use of the display unit and the operation unit.

The modes may include at least a navigation mode for performing a navigation function and an audio mode for reproducing audio data. The navigation mode may include a first navigation mode for displaying a map on a display unit with performing a route guide and a second navigation mode for displaying the map on the display unit without performing the route guide; and the audio mode may include a first audio mode for reproducing only the audio data and a second audio mode for reproducing both the audio data and visual data.

According to a second aspect of at least one embodiment of the present invention, there is provided a portable device which is mountable on an in-vehicle device, wherein the portable device has a plurality of modes; wherein the portable device includes a control unit which is configured to automatically select one mode from among the modes when the portable device is detached from the in-vehicle device; and wherein the one mode to be automatically selected by the control unit is user-presettable.

According to a third aspect of at least one embodiment of the present invention, there is provided an electronic device system, comprising: an in-vehicle device having a plurality of first modes; a portable device having a plurality of second modes; and a control unit which is configured to automatically select one mode from among the first modes and the second modes when the portable device is mounted on the in-vehicle device, wherein the one mode to be automatically selected by the control unit is user-presettable.

With the above configuration, the portable device can be set to the mode desired by the user when the portable device is mounted on or detached from the in-vehicle device. This is very convenient for the user

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1(a) is a schematic view illustrating an example of mounting an electronic device system 1 on a vehicle 2 according to an embodiment of the present invention;

FIG. 1(b) is a schematic view illustrating an example of using a portable device 10 and an in-vehicle device 100 according to the embodiment;

FIG. 2 is a schematic perspective view illustrating the electronic device system 1 in a state where the portable device 10 is mounted on the in-vehicle device 100 according to the embodiment;

FIG. 3 is a schematic perspective view illustrating the in-vehicle device 100 according to the embodiment;

FIG. 4 is a hexahedral schematic view illustrating the portable device 10 according to the embodiment;

FIG. 5 is a schematic view illustrating the electronic device system 1 in a state where a front unit 200 of the in-vehicle device 100 is tilted with respect to a main unit 300 according to the embodiment;

FIG. 6 is a block diagram illustrating a configuration of the electronic device system 1 according to the embodiment;

FIG. 7 is a diagram illustrating a mode setting screen for the electronic device system 1 after the portable device 10 is connected to the in-vehicle device 100, which is displayed on a display unit 14 of the portable device 10 according to the embodiment;

FIG. 8(a) is a diagram illustrating the electronic device system before the portable device 10 is connected to the in-vehicle device 100 according to the embodiment;

FIG. 8(b) is a diagram illustrating the electronic device system 1 after the portable device 10 is connected to the in-vehicle device 100 according to the embodiment;

FIG. 9(a) is an example of a table showing a mode of the electronic device system 1 when the portable device 10 is connected to the in-vehicle device 100 according to the embodiment;

FIG. 9(b) is an example of a table showing a mode of the portable device 10 after the portable device 10 is detached from the in-vehicle device 100 according to the embodiment;

FIG. 10(a) is a diagram illustrating a state where the portable device 10 in a power OFF state is about to be mounted on the in-vehicle device 100 in a power OFF state according to the embodiment;

FIG. 10(b) is a diagram illustrating a mode switching screen after the portable device 10 in the power OFF state is mounted on the in-vehicle device 100 in the power OFF state according to the embodiment;

FIG. 11 is a flowchart illustrating an output control process of the portable device 10 when the portable device 10 is connected to the in-vehicle device 100 according to the embodiment; and

FIG. 12 is a flowchart illustrating an output control process of the in-vehicle device 100 when the portable device 10 is connected to the in-vehicle device 100 according to the embodiment.

### DETAILED DESCRIPTION OF THE EMBODIMENTS

Hereinafter, embodiments of the invention will be described with reference to the drawings. The technical scope of the invention is not limited to these embodiments, and includes the invention described in Claims and equivalents thereof.

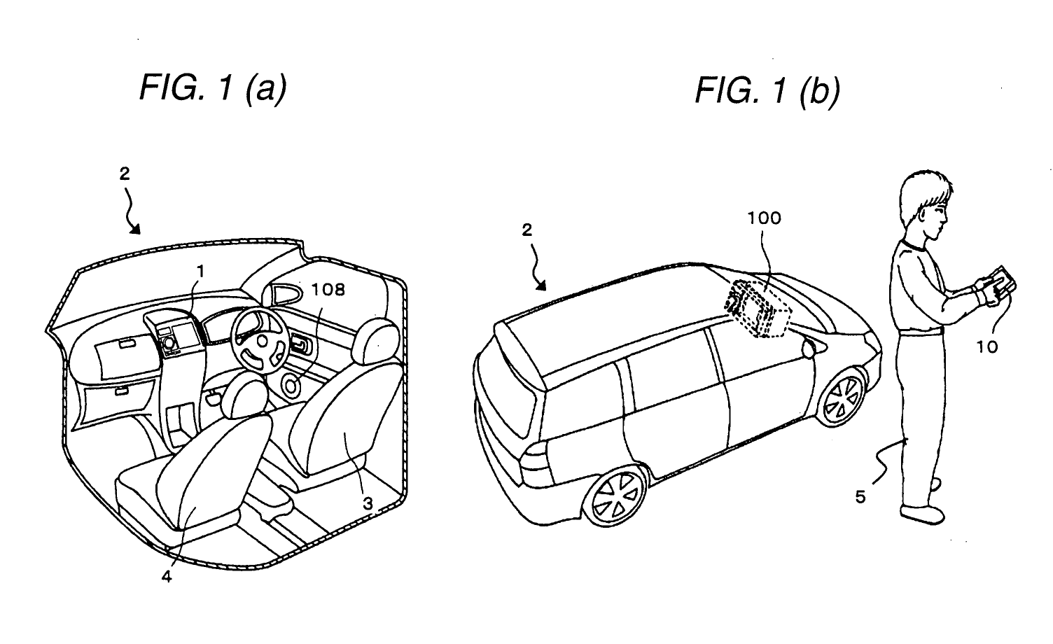

FIG. 1(a) is a schematic view illustrating an example of mounting an electronic device system 1 on a vehicle 2 according to an embodiment of the present invention and FIG. 1(b) is a schematic view illustrating an example of using a portable device 10 and an in-vehicle device 100 according to the embodiment. The electronic device system 1 is installed at a console part between a driver seat 3 and a passenger seat 4 in a vehicle 2, and can be used by a driver and a fellow passenger.

The electronic device system 1 includes a portable device 10 and an in-vehicle device 100, and the portable device 10 is attachable to and detachable from the in-vehicle device 100. The portable device 10 is a portable navigation device such as a PND (Personal/Portable navigation device). The portable device 10 can be used as a navigation device, a television radio receiver, or a recording medium reproducing device even when a user 5 is out of a car. The in-vehicle device 100 is a stationary in-vehicle device fixed to the vehicle, and can be used as a reproducing device and a receiving device such as a car audio and a visual audio, even when the portable device 10 is detached from the in-vehicle device 100. A speaker 108 can output the sound of music reproduced by, for example, a reproducing device to the interior of the car.

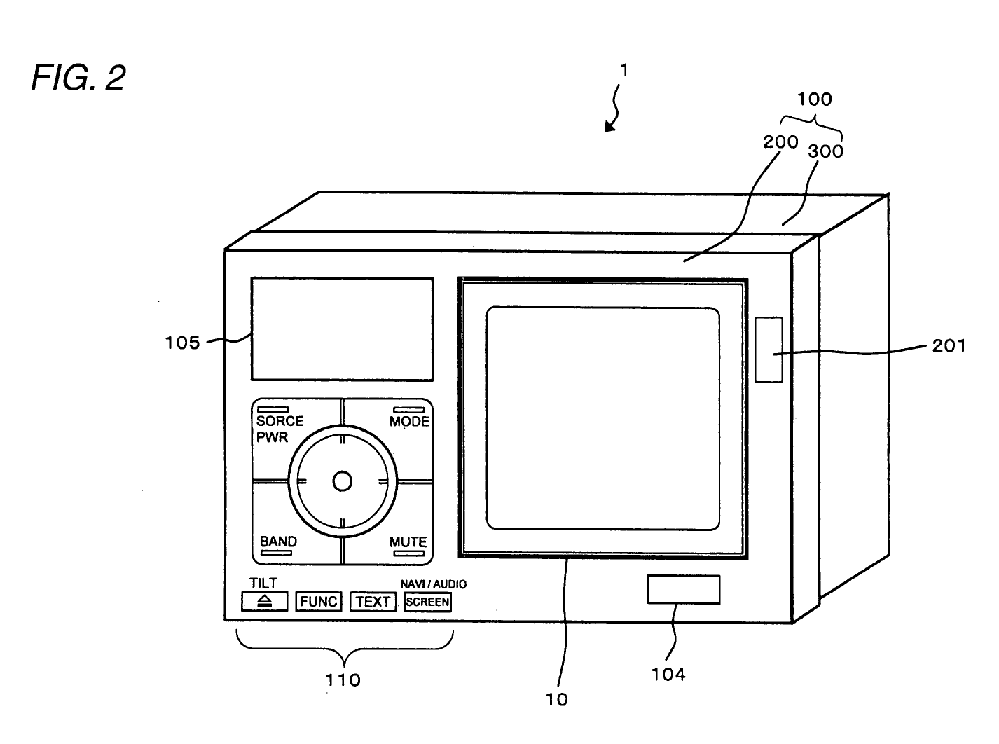

FIG. 2 is a schematic perspective view illustrating the electronic device system 1 in a state where the portable device 10 is mounted on the in-vehicle device 100 according to the embodiment. When the electronic device system 1 is used in a state shown in FIG. 2, the electronic device system 1 can perform a navigation function, a recording medium reproducing function for CDs (compact disc), DVDs (digital versatile disc), and BDs (Blu-ray disc), a radio receiving function, a television receiving function, and the like.

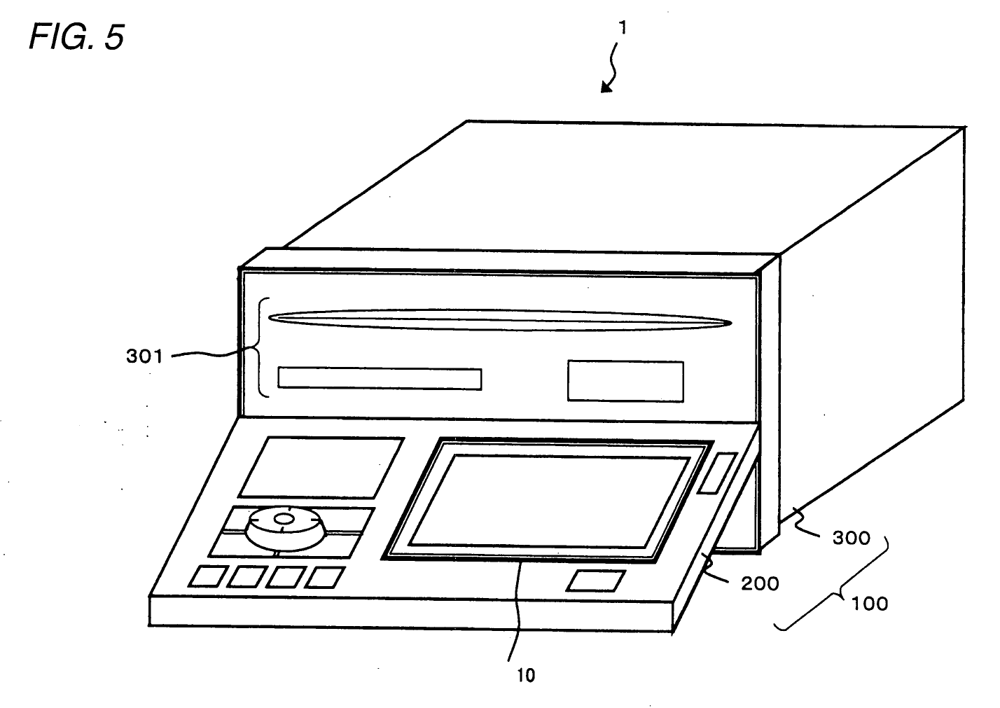

The in-vehicle device 100 includes a front unit 200 capable of performing a tilt operation and having a display unit 105 and an operation unit 110, and a main unit 300 having a reproducing unit for reading information from a recording medium. The display unit 105 has a liquid crystal panel and a backlight, and can display information regarding reproduced music and the like. The user can perform a mode switching operation and the other various operations via the operation unit 110. For example, the user can select one mode from among a plurality of modes, perform the tilt operation of the front unit 200, eject a recording medium from the main unit 300 and display a menu screen on the display unit 105, via the operation unit 110. A detachment button 201 is provided on the front unit 200. The user can detach the portable device 10 from the in-vehicle device 100 (front unit 200) by operating this detachment button 201. When the detachment button 201 is operated, a lock mechanism is released between the portable device 10 and the in-vehicle device 100 (front unit 200). To detach the portable device 10 from the front unit 200, for example, the lock mechanism between the portable device 10 and the front unit 200 may be released, and then only the portable device 10 may be protruded from the front face of the front unit 200 without moving the front unit 200. For another example, the front panel 200 may be tilted to a predetermined angle with respect to the main unit 300 as shown in FIG. 5, and then the lock mechanism may be released. The front panel 200 may be tilted to be a horizontal state. Accordingly, the user can easily detach the portable device 10 from the front panel 200 in these ways. Reference numeral 104 denotes an external audio/video input/output unit.

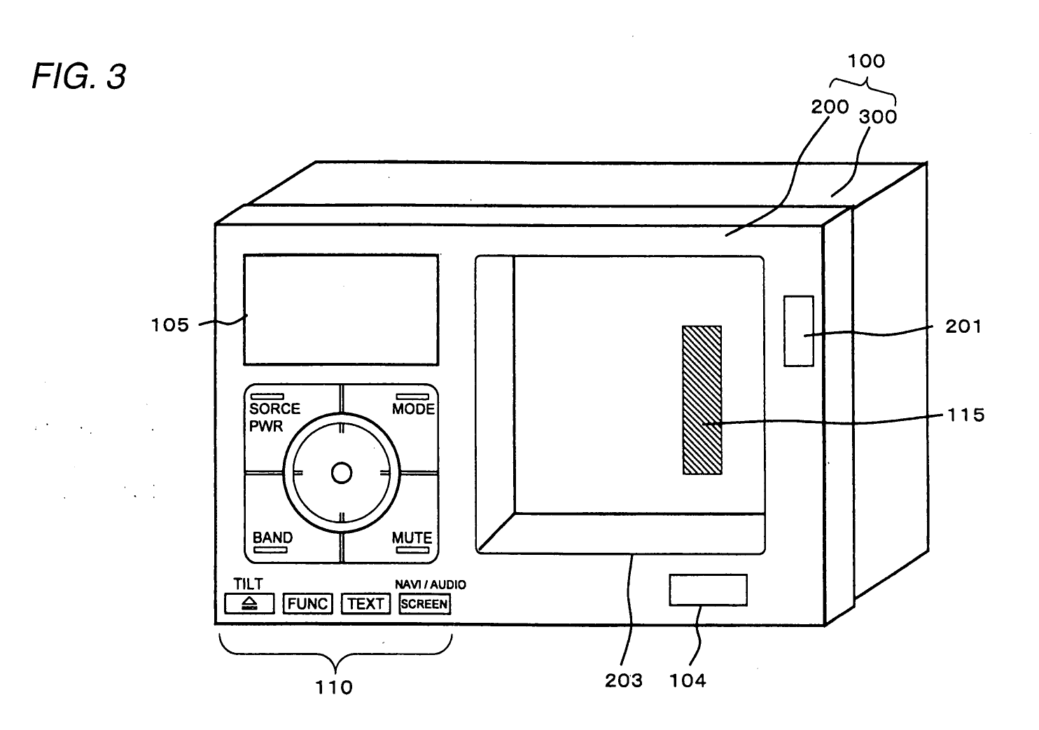

FIG. 3 is a schematic perspective view illustrating the in-vehicle device 100 according to the embodiment. In FIG. 3, the portable device 10 is detached from the in-vehicle device 100. An attachment/detachment portion 203 is provided with a concave portion for accommodating the portable device 10 therein, a connector 115 for electrically connect the in-vehicle device 10 to the portable device 10, and a lock mechanism (not shown) for fixing the portable device 10 to the front unit 200 of the in-vehicle device 100.

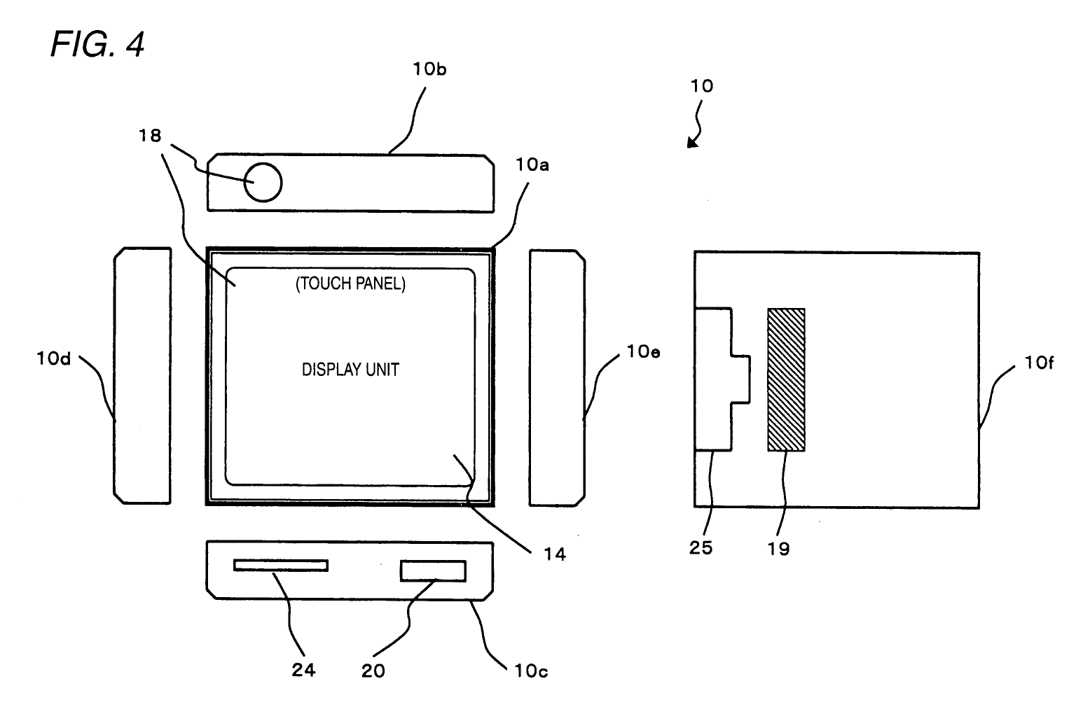

FIG. 4 is a hexahedral schematic view illustrating the portable device 10 according to the embodiment. The portable device 10 is provided with a display unit 14 and an operation unit 18. The display unit 14 is provided on the front face 10a of the portable device 10 and includes a liquid crystal panel and a backlight. A display regarding the navigation function such as a map display with or without a route guide display, information regarding a received information program of a radio or a television, or information regarding reproduced music such as MP3 (MPEG Audio Layer-3) files can be displayed on the display unit 14. The operation unit 18 includes a touch panel provided on the front face 10a of the portable device 10 and a power button of the portable device 10 provided on the top face 10b of the portable device 10. When the portable device 10 is mounted on the in-vehicle device 100, the power of the portable device 10 is controlled (turned on and off) by the in-vehicle device 100. When the portable device 10 is detached and used as a single unit, the power is controlled (turned on and off) by this power button.

A connector 19 and a locking portion 25 to lock The portable device 10 to the in-vehicle device 100 are provided on the back face 10f of the portable device 10. A slot 24 for a card memory or a USB memory and a wireless communication unit 20 are provided on the bottom face 10c of the portable device 10. When the card memory or the USB memory storing map information is inserted into the slot 24, the portable device 10 can display the map information and perform the navigation function. The wireless communication unit 20 can acquire information used for the navigation function or transmission/reception of sound signals of phone communication from and to a mobile phone, for example, using Bluetooth (Trade Mark) that is a wireless transmission method using a 2.4 GHz band.

FIG. 5 is a schematic view illustrating the electronic device system 1 in a state where a front unit 200 of the in-vehicle device 100 is tilted (inclined) with respect to a main unit 300 according to the embodiment. When the front unit 200 is tiled, the portable device 10 is also tilted according thereto. Then, a recording medium such as a CD, a DVD, and a flash memory can be inserted and ejected from an insertion/ejection port 301 of the main unit 300. The recording medium inserted into the insertion/ejection port 301 is reproduced by a recording medium reproducing unit (described later) provided in the main unit 300.

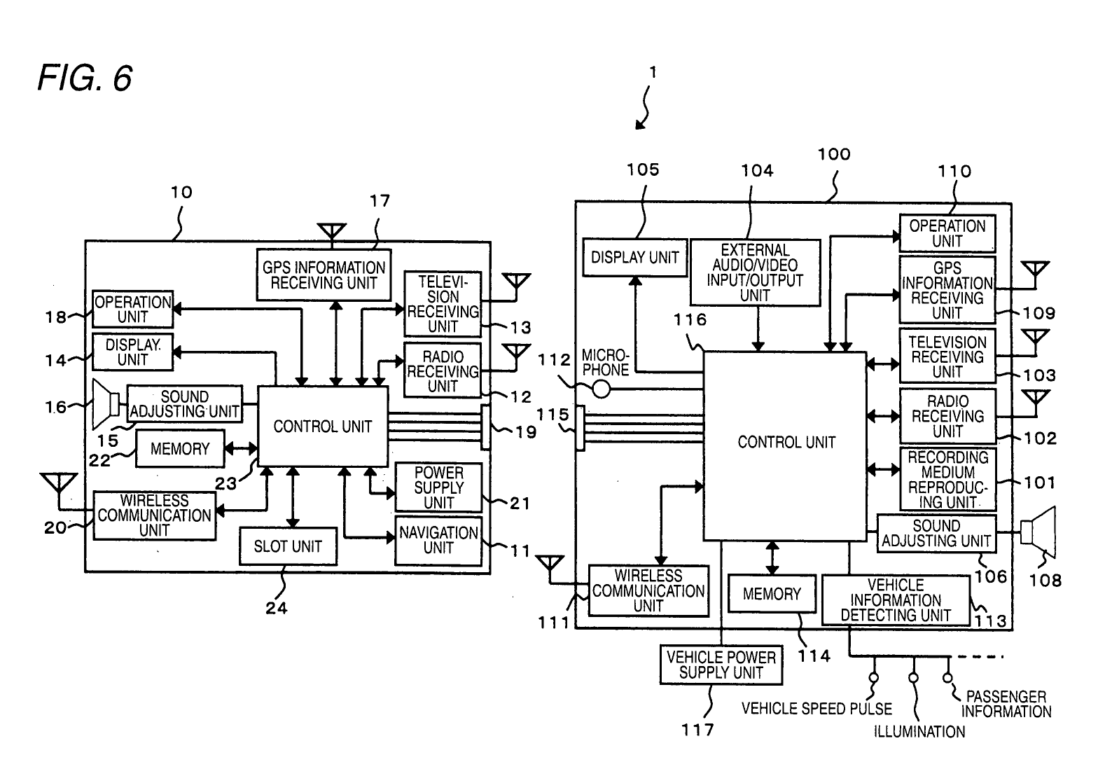

FIG. 6 is a block diagram illustrating a configuration of the electronic device system 1 according to the embodiment. The in-vehicle device 100 includes a recording medium reproducing unit 101, a radio receiving unit 102, a television receiving unit 103, an external audio/video input/output unit 104, a display unit 105, a sound adjusting unit 106, GPS (Global Positioning System) information receiving unit 109, an operation unit 110, a wireless communication unit 111, a microphone 112, a vehicle information detecting unit 113, a memory 114, a connector 115, and a control unit 116, which will be described in detail.

The recording medium reproducing unit 101 can reproduce a recording medium, for example, an optical disc such as a CD, a DVD, or a Blu-ray and a non-volatile semiconductor device memory such as a flash memory and a hard disk, in which store music data, text data, image data, map data for navigation, and the like. The recording medium reproducing unit 101 outputs video to the display unit 105 and outputs audio to the speaker 108 installed in the vehicle. The radio receiving unit 102 is connected to an antenna installed on the vehicle, receives AM/FM radio and broadcasting waves such as multi-broadcasting, satellite broadcasting, and digital radio. The radio receiving unit outputs stereo sound signals, and receives and demodulates multi-data. Similarly, the television receiving unit 103 receives, demodulates, and outputs analog television or digital television (12 SEG, 1 SEQ) and satellite broadcasting through the antenna installed on the vehicle. The external audio/video input/output unit 104 inputs audio or video from a vehicle surroundings monitoring camera for imaging the surroundings of the vehicle, a drive recorder for recording the surroundings of the vehicle during driving, and other AV (Audio Visual) devices, as well as outputting audio and video to an external display device such as a vehicle back seat monitor. The display unit 105 displays reproduced information, channel information, input/output information, and the like of the recording medium reproducing unit 101, the television receiving unit 103, and the external audio/video input/output unit 104. When the portable device 10 is mounted through the connector 115, the display unit 105 may display output information on the portable device 10. For example, when the portable device 10 is displaying a map, the display unit 105 may display a wider map or information on the surroundings. When the portable device 10 is receiving television, the display unit 105 may display a program list. The sound adjusting unit 106 adjusts the quality or volume of the navigation sound, television sound, radio sound, and the like. The OPS information receiving unit 109 is connected to the antenna installed on the vehicle and receives positional information from a satellite, to calculate a position of the GPS information receiving unit 109. As described above, the operation unit 110 performs a switching operation to various modes, and an input/selection operation in each mode. As described above, the wireless communication unit 111 transmits and receives signals to and from external devices or the in-vehicle device 100 through a wireless communication line or a public line such as mobile phone communication and Bluetooth (Trade Mark) infrared communication. The microphone 112 records a user's voice or sound in the vehicle, and perform voice recognition, which can be used for various operations. The vehicle information detecting unit 113 detects vehicle information (such as vehicle speed pulse information related to vehicle driving speed, headlight illumination information, passenger information on each seat in the vehicle, fuel efficiency information, air conditioner settings information) through, for example, an in-vehicle LAN. In the memory 114, there are stored various kinds of setting information in the in-vehicle device 100 based on image quality, sound quality, reception channel frequency, and vehicle information. As described above, the connector 115 is electrically connected to the portable device 10 and is used to transmit and receive information. Specifically, the connection 115 is used to transmit and receive mode setting information of the portable device 10. The control unit 116 controls the above-described units overall. When an engine key (not shown) is located at ACC or IG, electric power is supplied from a power supply unit 117 provided in the vehicle to the in-vehicle device 100.

Next, the portable device 10 will be described in detail. The portable device 10 includes a navigation unit 11, a radio receiving unit 12, a television receiving unit 13, a display unit 14, a sound adjusting unit 15, a speaker 16, a GPS information receiving unit 17, an operation unit 18, a connector 19, a wireless communication unit 20, a power supply unit 21, a memory 22, and a control unit 23. Each of the units will be described in detail. The overlapping description regarding parts having the same names as the above-described parts of the in-vehicle device 100 is omitted.

The navigation unit 11 performs a route search or a route guide on the basis of the map information stored in the memory 22. However, when the portable device 10 is mounted on the in-vehicle device 100 through the connector 19, the navigation unit 11 may acquire the map information stored in the recording medium reproducing unit 101 or in the memory 114 of the in-vehicle device 100. The display unit 14 adjusts and displays an image such as the above-described navigation image or television image. When the portable device 10 is mounted on the in-vehicle device 100 through the connector 19 and vehicle information is detected by the vehicle information detecting unit 113 of the in-vehicle device 100, the display unit 14 may display information on fuel efficiency or the state of the air conditioner and the like on the basis of the detected vehicle information, for the improved convenience of the user. The operation unit 18 includes the touch panel provided on the surface of the display unit 14 and the power switch provided on the top face 10b of the portable device 10. The connector 19 is connectable to the connector 115 of the in-vehicle device 100, and is used to supply electric power or receive the vehicle information (vehicle driving speed, headlight illumination information, passenger information, fuel efficiency information, air conditioner setting, etc.), and to transmit and receive the mode setting information of the in-vehicle device 100. The power supply unit 21 supplies electric power to each unit in the portable device 10 when the portable device 10 is used as a single unit, and is a storage battery capable of charging electric power when the power supply unit 21 is connected to the in-vehicle device 100 or to an external adaptor. In consideration of the size of the portable device 10, the memory 22 includes a 1.8 inch small-size hard disk, a flash memory, a detachable IC memory card (SD card, mini SD/micro SD, Memory Stick (Trade Mark), Compact Flash (Trade Mark), etc.), a card-type HDD (micro drive), and the like, and stores various kinds of setting information of the portable device 10 based on the map information or reception channel frequency vehicle information of each medium, mode information of the portable device 10 and the in-vehicle device 100, and the like. The memory or the like inserted to the slot unit 24 has the same function as that of the memory 22, and the memory 114 in the in-vehicle device 100 may be the same type. The control unit 23 has overall control of each of the units in the portable device 10.

The configurations have been described above, but the constituent units commonly provided in the portable device 10 and the in-vehicle device 100 may be provided only one of the portable device 10 and the in-vehicle device 100 depending on the basis of the viewpoint of cost, shape, size, weight, and the like. For example, as long as the display unit 14 is provided in the portable device 10, the display unit 105 may be omitted from the in-vehicle device 100.

Next, the mode of the electronic device system 1 when the portable device 10 is mounted on the in-vehicle device 100 will be described.

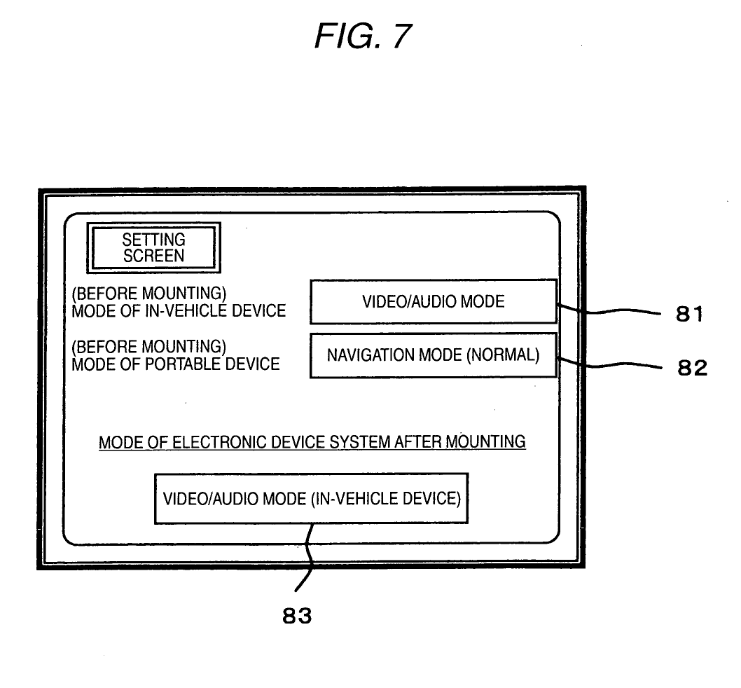

As described above, each of the portable device 10, the in-vehicle device 100 and their combination (the electronic device system 1) can perform a plurality of functions. To perform each function, each of the portable device 10, the in-vehicle device 100, and the electronic device system 1 has a plurality of modes. That is, the portable device 10 (the in-vehicle device 100, or the electronic device system 1) can perform one function when the portable device 10 (the in-vehicle device 100, or the electronic device system 1) is set to one mode related to the one function, which is selected from among the plurality of modes. The plurality of modes includes not only the function modes but also an on mode and an off mode. FIG. 7 is a diagram illustrating a mode setting screen for the electronic device system 1 after the portable device 10 is connected to the in-vehicle device 100. The mode setting screen is displayed on a display unit 14 of the portable device 10. Reference numeral 81 denotes a part for selecting a mode of the in-vehicle device 100 before connection (before the portable device 10 is connected to the in-vehicle device 100), and reference numeral 82 denotes a part for selecting a mode of the portable device 10 before connection. Reference numeral 83 denotes a part for selecting a mode of the electronic device system 1 when the portable device 10 is mounted on the in-vehicle device 100 in the modes selected in the parts 81 and 82. As a setting method in the setting screen shown in FIG. 7, when the corresponding item is selected by operating the touch panel (operation unit 18 in FIG. 4), selection items may be displayed in a list or the item may be changed every time the item is clicked. In addition, a list table of the modes may be displayed on the display unit so that the user uses the list table for setting. “(IN-VEHICLE DEVICE)” of the items in the setting screen means “MODE OF IN-VEHICLE DEVICE IS CARRIED OVER”. As described above, the user can freely set the mode of the electronic device system 1 when the portable device 10 is mounted on the in-vehicle device 100, by the setting screen. In other words, the user can preset a mode to be automatically selected when the portable device 10 is mounted on the in-vehicle device 100.

For example, in FIG. 7, a video/audio mode, such as DVD and TV, is selected as the mode 81 of the in-vehicle device 100 before mounting (before the portable device 10 is mounted on the in-vehicle device 100), a navigation mode (normal) such as map display without route guide is selected as the mode 82 of the portable device 10 before mounting, and a video/audio mode (in-vehicle device) is selected as the mode 83 of the electronic device system 1 after mounting (after the portable device 10 is mounted on the in-vehicle device 100). Since the setting screen for performing the mode setting is displayed on the display unit 14 of the portable device 10, which has a wide display area for displaying the map in the navigation mode, the user can easily set the mode.

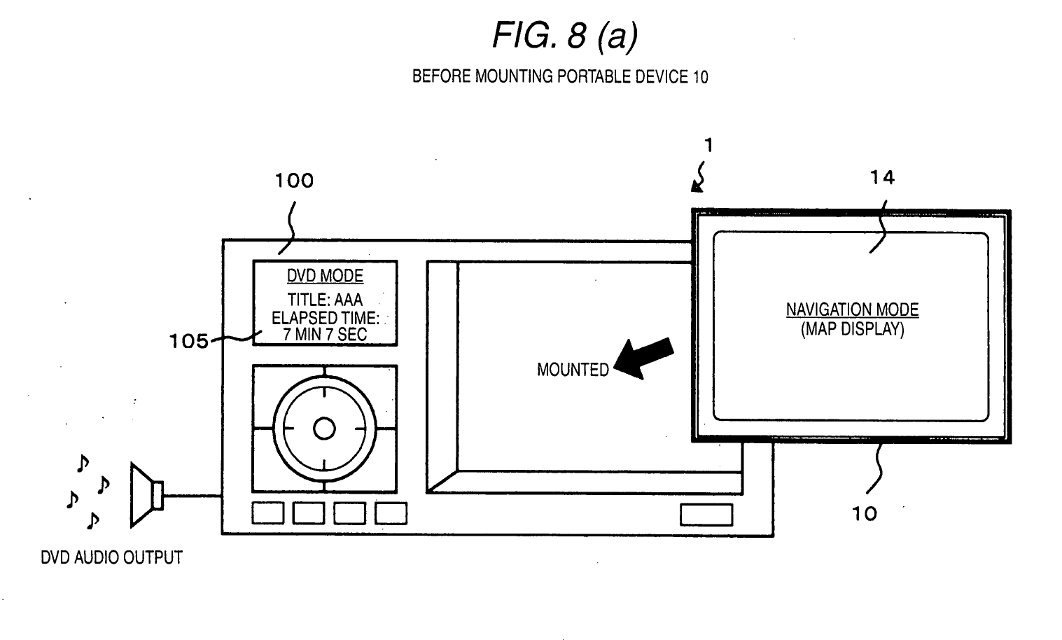

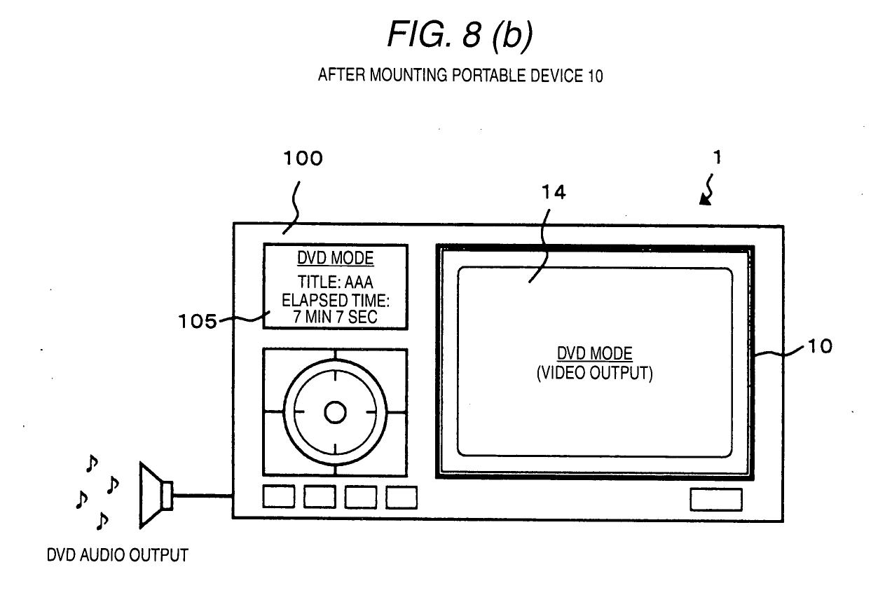

FIG. 8(a) is a diagram illustrating the electronic device system before the portable device 10 is connected to the in-vehicle device 100 and FIG. 8(b) is a diagram illustrating the electronic device system 1 after the portable device 10 is connected to the in-vehicle device 100. As shown in FIG. 8(a), the portable device 10 is set to the navigation mode (map display) and the in-vehicle device 10 is set to the DVD mode (an example of video and audio mode) before the portable device 10 is mounded on the in-vehicle device 100.

As shown in FIG. 8(b), when the portable device 10 which is displaying the map in the navigation mode, is mounted on the in-vehicle device 100 which is reproducing the information stored in the DVD in the DVD mode, the DVD video reproduced by the in-vehicle device 100 is displayed on the display unit 14 of the portable device 10 on the basis of the mode set in FIG. 7. That is, the portable device 10 is automatically switched from the navigation mode to the DVD mode at the same time of mounting the portable device 10 on the in-vehicle device 100. As described above, the user can operate the electronic device system 1 in the desired mode with a simple operation. Here, “mount”, “connect” and “attach” means at east mechanical connection between the portable device 10 and the in-vehicle device 100. That is, when the portable device 10 is mounted on (connected to, attached to) the in-vehicle device 100, the connector 19 of the portable device 10 is not necessarily electrically connected to the connector 115 of the in-vehicle device 100. The mode of the portable device 10 may be automatically changed based on the mode set in FIG. 7 when it is detected that the portable device 10 is mechanically mounted on the in-vehicle device 100.

On the contrary, in the related-art, even when the portable device 10 is mounted on the in-vehicle device 100, the portable device 10 continues in the navigation mode and the map is displayed on the display unit 14. That is, if the user wants to continue to display video or DVD on the display unit 14 of the portable device 10, the user needs to change the mode of the portable device 10 (the mode of the electronic device system 1) after mounting. This is a troublesome operation for the user.

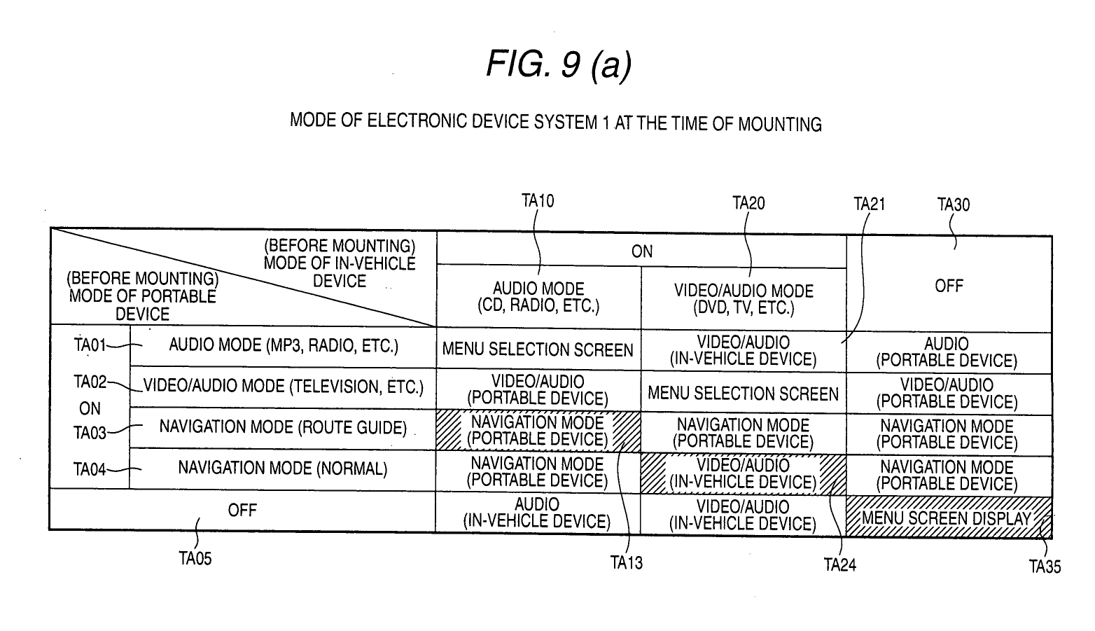

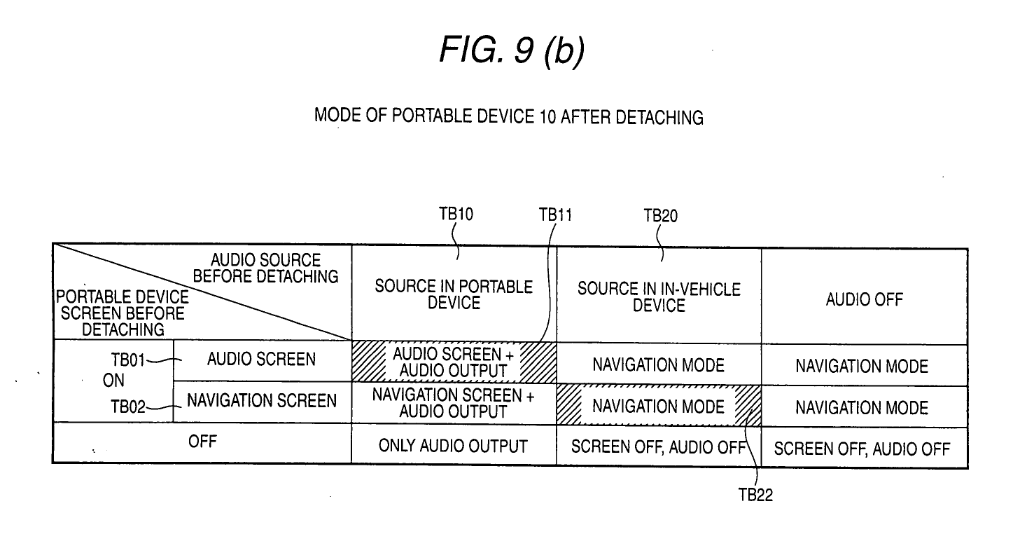

Next, the modes of the portable device 10, the in-vehicle device 100, and the electronic device system 1 according to the invention will be described with reference to FIGS. 9(a) and 9(b).

FIG. 9(a) is an example of a table showing a mode of the electronic device system 1 when the portable device 10 is connected to the in-vehicle device 100.

In FIG. 9(a), the horizontal axis indicates the modes of the in-vehicle device 100 before mounting the portable device 10 on the in-vehicle device 100. There are items such as an audio mode (TA10) for outputting audio of CD, radio, and the like, a video/audio mode (TA20) for outputting video and audio of DVD, TV, and the like, and a power OFF state (TA30). The vertical axis indicates the modes of the portable device 10 before mounting the portable device 10 on the in-vehicle device 100. There are items such as an audio mode (TA01) for outputting audio of MP3, radio, and the like, a video/audio mode (TA02) for outputting video and audio for TV and the like, a navigation mode (route guide) (TA03) for displaying a map with the route guide and a navigation mode (normal) (TA04) for displaying the map without the route guide, and a power OFF state (TA05). “(PORTABLE DEVICE)” and “(IN-VEHICLE DEVICE)” mean “MODE OF PORTABLE DEVICE IS CARRIED OVER” and “MODE OF IN-VEHICLE DEVICE IS CARRIED OVER”. In the audio mode (CD, radio, MP3), the display unit may display reproduction information, reception information or a still image. Nothing may be displayed on the display unit in the audio mode (CD, radio, MP3). In addition, the reproducing unit or the receiving unit in each device is used for a source (CD, radio, MP3, DVD, TV, etc.) in the audio mode or the video/audio mode of each device.

The mode of the electronic device system 1 after mounting (after the portable device 10 is mounted on the in-vehicle device 100) is represented in a table in which each item (TA10 to TA30) of the in-vehicle device mode before mounting (before the portable device 10 is mounted on the in-vehicle device 100) and each item (TA01 to TA05) of the portable device mode before mounting intersect with each other. The mode of the electronic device system 1 after mounting (the common mode of the portable device 10 and the in-vehicle device 100) is user-presettable. In the above-described example in FIG. 7 and FIG. 9(a), the in-vehicle device mode 81 before mounting corresponds to the item of TA20, the portable device mode 82 before mounting corresponds to the item of TA04, and the in-vehicle system mode 83 after mounting corresponds to the item of TA 24. For example, when the portable device 10 (TA03) which guides the route in the navigation mode is mounted on the in-vehicle device 100 (TA10) which reproduces a CD in the audio mode, the mode of the portable device 10 before mounting may be carried over (TA13) under the presumption that priority is given to the route guide of the portable device 10.

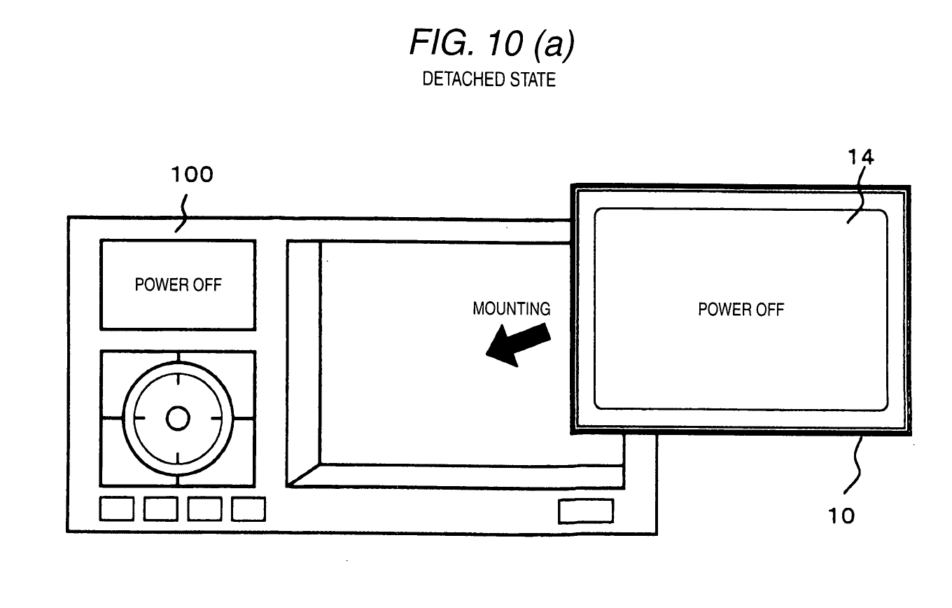

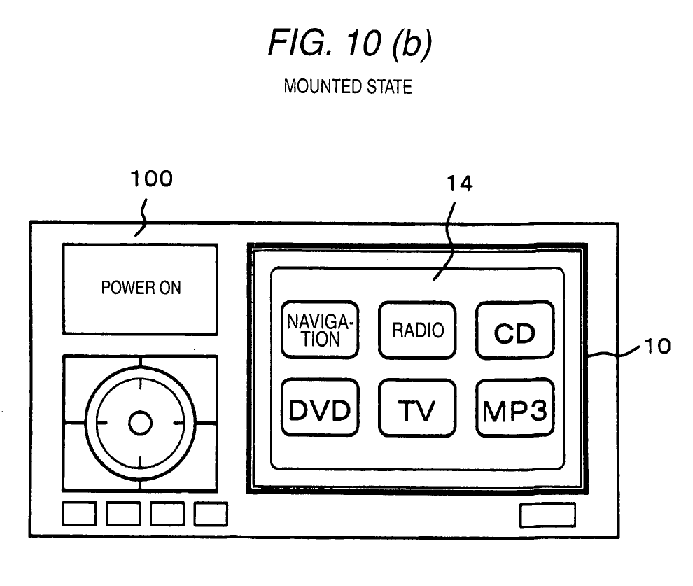

As shown in FIG. 10(a), when both the in-vehicle device 100 and the portable device 10 are turned off (TA30, TA05), the in-vehicle device 100 and the portable device 10 are automatically turned on to display a menu screen (screen for selecting modes of navigation) radio, CD, DVD, TV, MP3, etc.) (TA35) as shown in FIG. 10(b) so that the user can immediately select a mode of the electronic device system 1. As described above, since the mode of the electronic device system 1 can be previously set by the user on the basis of the modes of the portable device 10 and the in-vehicle device 100, convenience can be remarkable improved. In addition, since the menu screen is displayed on the display unit 14 of the portable device 10 having the wide display area for displaying the map in the navigation mode, the user can easily select the mode. The user may select the source (navigation, radio, CD, DVD, TV, MP3, etc.) to be displayed on the menu screen.

FIG. 9(b) is an example of a table showing a mode of the portable device 10 after the portable device 10 is detached from the in-vehicle device 100. As shown in FIG. 9(b), the mode of the portable device 10, after the portable device 10 is detached from the in-vehicle device 100, can be previously set. In other words, the mode to be automatically selected when the portable device 10 is detached from the in-vehicle device 100 is user-presettable. For example, when the electronic device system 1 before detaching (before the portable device 10 is detached from the in-vehicle device 100) outputs audio from the audio source (e.g., MP3 music data store in the memory card) in the portable device 10 (TB10) and displays reproduction information (audio screen) on the display unit 14 (TB01), the portable device will continuously display the reproduction information (audio screen) on the display unit 14 and output the audio (TB11) after detaching (after the portable device 10 is detached from the in-vehicle device 100). Accordingly, the user can listen to the music stored in the portable device 10 outside the car only by detaching the portable device 10 from the in-vehicle device 100 without performing the mode changing operation.

In addition, for example, when the audio source of the electronic device system 1 before detaching is a source in the in-vehicle device 100 (e.g., music CD) (TB20) and the displayed screen is the navigation screen (TB02), the portable device 10 after detaching may set to the navigation mode (TB22) to display the navigation screen without outputting the audio from the audio source. With such a configuration, the portable device 10 can be automatically set to the desired mode at the time of detaching, and thus convenience is improved. The mode of the in-vehicle device 100 at the time of detaching may be set in the same manner. The mode of the in-vehicle device 100 after detaching may be return to a mode of the in-vehicle device 100 before mounting.

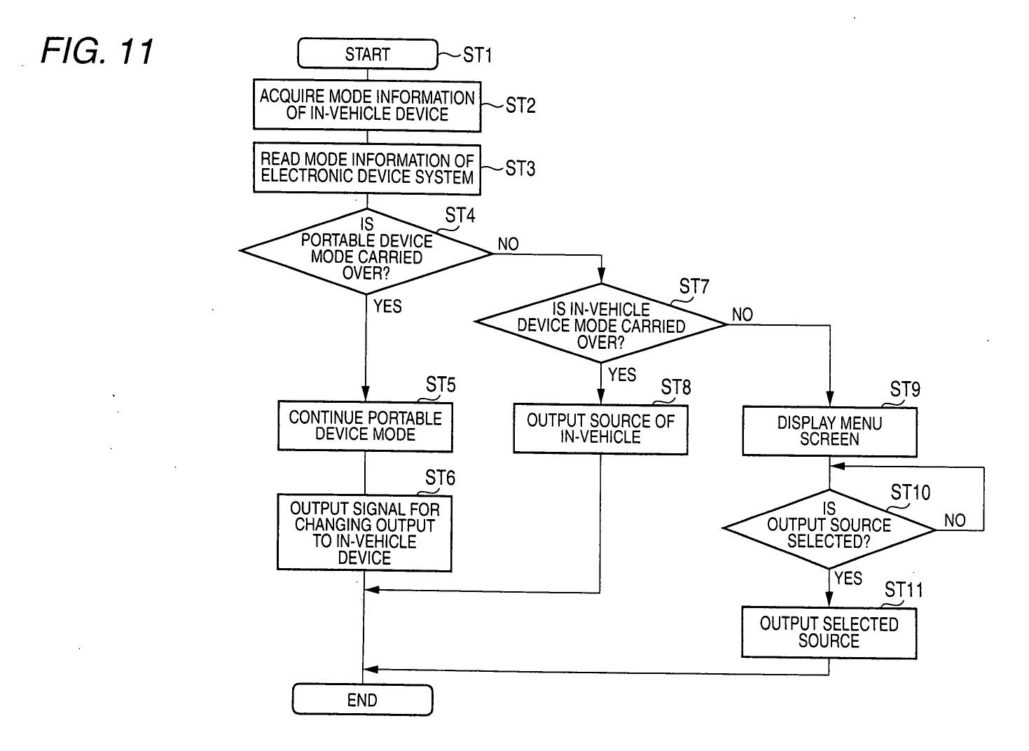

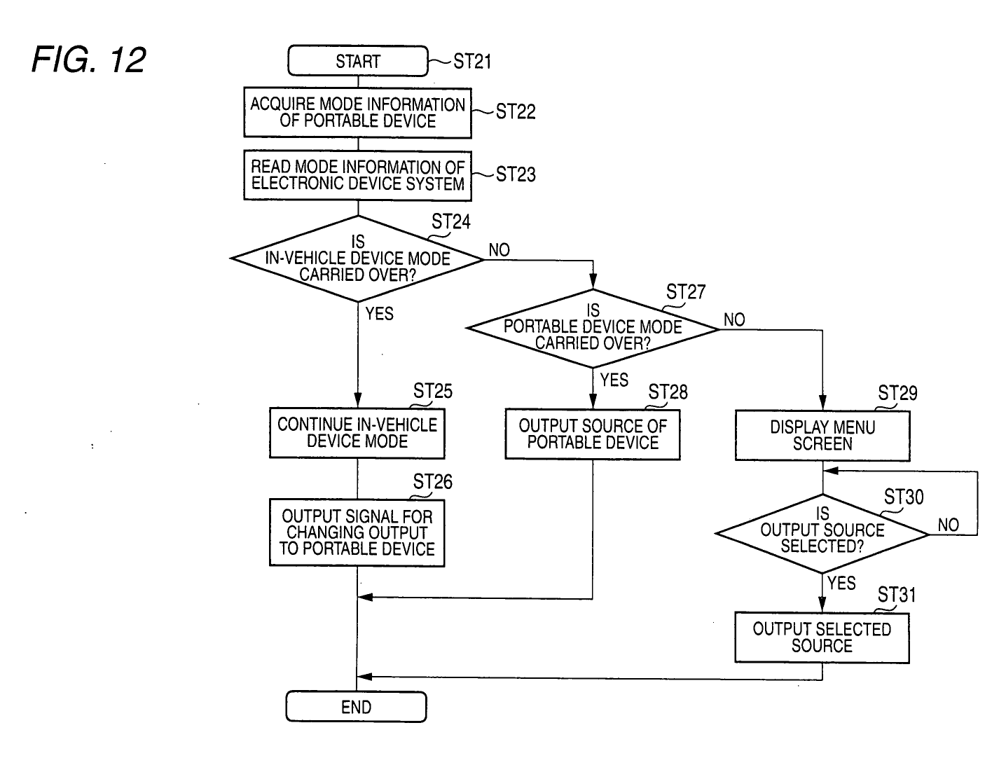

Next, an output control of the portable device 10 and the in-vehicle device 100 when the portable device 10 is mounted on the in-vehicle device 100 will be described with reference to FIG. 11 and FIG. 12.

FIG. 11 is a flowchart illustrating an output control process of the portable device 10 when the portable device 10 is connected to the in-vehicle device 100. When the control unit 23 of the portable device 10 detects a connection signal transmitted from a connection unit 19, the process is started (ST1). First, the control unit 23 acquires information regarding the mode of the in-vehicle device 100 through the connection unit 19 (ST2). The control unit 23 reads information regarding the mode of the electronic device system 1 based on the modes of the portable device 10 and the in-vehicle device 100 before mounting, from the table shown in FIG. 9(a), which is stored in the memory 22 (ST3). The control unit 23 determines whether or not the read information regarding the mode of the electronic device system 1 represents that the mode of the portable device 10 is carried over (ST4). When the read information represents that the mode of the portable device 10 is carried over, the mode of the portable device 10 continues as it is (ST5). A signal for changing the output of the in-vehicle device 100 to be consistent with the output of the mode of the portable device 10 is output to the control unit 116 of the in-vehicle device 100 (ST6). That is, the in-vehicle device 100 is controlled according to the mode of the portable device 10, and the mode (operation) can be united as the electronic device system 1. When the read information regarding the mode of the electronic device system 1 does not represent that the mode of the portable device 10 is carried over, the control unit 23 determines whether or not the read information regarding the mode of the electronic device system 1 represents that the mode of the in-vehicle device 100 is carried over (ST7). When the read information represents the mode of the in-vehicle device 100 is carried over, the output data is acquired from the in-vehicle device 100 and the data is displayed on the display unit 14 of the portable device 10 as the electronic device system 1 or the data is output as audio (ST8). When the read information represents that neither the mode of the portable device 10 nor the mode of the in-vehicle device 100 are carried over, the menu screen, on which the user can select one source from among the plurality of sources, is displayed on the display unit 14 (ST9). When the source is selected by the user (ST10), the source selected as the electronic device system 1 is output (ST11). With such a process, it is possible to perform the output according to the preference of the user. According to the above-described process, the modes of the portable device 10 and the in-vehicle device 100 after the portable device 10 is mounted on the in-vehicle device 100 are automatically switched considering the convenience for the user, and the usage style of the user can be reflected, thereby improving the convenience.

FIG. 12 is a flowchart illustrating an output control process of the in-vehicle device 100 when the portable device 10 is connected to the in-vehicle device 100. When the control unit 116 of the in-vehicle device 100 detects a connection signal transmitted from a connection unit 115, the process is started (ST21). First, the control unit 116 acquires information regarding the mode of the portable device 10 through the connector 115 (ST22). The control unit 116 reads information regarding the mode of the electronic device system 1 based on the modes of the portable device 10 and the in-vehicle device 100 before mounting, from the table shown in FIG. 9(a), which is stored in the memory 114 (ST23). The control unit 116 determines whether or not the read information regarding the mode of the electronic device system 1 represents that the mode of the in-vehicle device 100 is carried over (ST24). When the read information represents that the mode of the in-vehicle device 100 is carried over, the mode of the in-vehicle device 100 continues as it is (ST25). A signal for changing the output of the portable device 10 to be consistent with the output of the mode of the in-vehicle device 100 is output to the control unit 23 of the portable device 10 (ST26). When the read information regarding the mode of the electronic device system 1 does not represent that the mode of the in-vehicle device 100 is carried over, the control unit 116 determines whether or not the read information regarding the mode of the electronic device system 1 represents that the mode of the portable device 10 is carried over (ST27). When the read information represents that the mode of the portable device 10 is carried over, the output data is acquired from the portable device 10 and the data is displayed on the display unit 14 of the portable device 10 as the electronic device system 1 or the data is output as audio (ST28). When the read information represents that neither the mode of the in-vehicle device 100 nor the mode of the portable device 10 are carried over, the menu screen, on which the user can select one source from among the plurality of sources, is displayed on the display unit 14 (ST29). When the source is selected by the user (ST30), the source selected as the electronic device system 1 is output (ST31). With such a process, it is possible to perform the output according to the preference of the user. According to the above-described process, the modes of the portable device 10 and the in-vehicle device 100 after the portable device 10 is mounted on the in-vehicle device 100 are automatically switched considering the convenience for the users and the usage style of the user can be reflected, thereby improving the convenience.

In FIG. 11, the in-vehicle device 100 is controlled using the information regarding the modes stored in the memory 22 and the control unit 23 of the portable device 10. In FIG. 12, the portable device 10 is controlled using the information regarding the modes stored in the memory 114 and the control unit 116 of the in-vehicle device 100. However, the invention is not limited thereto, and the modes and the outputs of the portable device 10 and the in-vehicle device 100 may be controlled using the information regarding the modes stored in any one of the memory units and any one of the control units, as the electronic device system 1.

In the above description, the case of mounting has been mainly described. However, as shown in FIG. 9(b), the information regarding the modes after detaching may be stored in the memory of each device, and the mode can be changed to the mode desired by the user with reference to the information.

In the above-described example, when both of the in-vehicle device 100 and the portable device 10 are turned off, the menu screen is displayed, but the invention is not limited thereto. When the portable device 10 is mounted on the in-vehicle device 100, the menu screen may be constantly displayed. When the portable device 10 is mounted on the in-vehicle device 100, the electronic device system 1 is switched to any one of the mode of the in-vehicle device 100, the mode of the portable device 10, and the menu screen display, but the invention is not limited thereto. When the portable device 10 is mounted on the in-vehicle device 100, the mode may be switched to another mode except for the above modes. That is, for example, the mode may be constantly switched to the navigation mode, irrespective of the mode of the in-vehicle device 100, the mode of the portable device 10, or the menu screen display.

The modes of the portable device 10 and the in-vehicle device 100 have been described above. Hereinafter, examples of the other functions of the portable device 10 and the in-vehicle device 100 will be described.

The memory 22 of the portable device 10 stores the map data, but may receive and store new map data, updated map data, and the like through the wireless communication unit 20. Accordingly, it is unnecessary to exchange the memory, and thus it is possible to easily update the map data.

When the portable device 10 is connected to the in-vehicle device 100, the map data stored in the memory 14 of the portable device 10 is not used but the map data (acquired from the memory 115 or the recording medium reproducing unit 101) of the in-vehicle device 100 may be used. Accordingly, it is possible to provide beneficial information for the user through the map data of the in-vehicle device 100 without increasing the capacity of the memory 14 of the portable device 10. The portable device 10 may acquire specific map data and the like specified in sightseeing information or local information, which is not stored in the memory 22 of the portable device 10, from the in-vehicle device 100 through the connection unit 19. Accordingly, it is possible to provide beneficial information for the user without increasing the capacity of the memory 22 of the portable device 10. The map data may be updated by determining a region or a country at the present position and automatically reading a map of the region and the country. Accordingly, it is possible to update only the necessary map data, and it is possible to reduce the process load of the portable device 10.

The portable device 10 can acquire traffic information such as traffic congestion information and road construction information from an information terminal provided in a side strip or the like through the wireless communication unit 20, and may reflect the traffic information to the map display or the route guide of the navigation. Accordingly, it is possible to provide beneficial information for the user.

When the user carries the portable device 10 outside the car, information on the surroundings such as store information in the vicinity of the present position may be acquired. Accordingly, it is possible to provide beneficial information for the user. It may be selected whether or not the information is acquired. Accordingly, when there is a fee for communication, it is possible to suppress the communication fee.

In a state where the user is watching television or listening to radio using the portable device 10, when the portable device 10 is attached to the in-vehicle device 100, the antenna may be changed from the antenna of the television receiving unit 13 or the radio receiving unit 12 of the portable device 10 used for the reception, to the antenna of the television receiving unit 103 or the radio receiving unit 102 of the in-vehicle device 100. Accordingly, it is possible to provide the user with high-quality video or audio using the antenna of the television receiving unit 103 or the radio receiving unit 102 having high reception sensitivity of the in-vehicle device 100. In addition, the antenna type can be changed to a so-called diversity type using the antenna of the portable device 10 and the antenna of the in-vehicle device 100. Accordingly, the reception sensitivity is improved, as compared with the case of reception using only the portable device 10 which is mounted on the in-vehicle device 100 and the reception sensitivity of which is weaker.

A region or a country including the present position may be specified using the GPS information receiving unit 17 of the portable device 10 or the GPS information receiving unit 109 of the in-vehicle device 100, and various settings (language, image quality, sound, etc.) of the portable device 10 or the in-vehicle device 100 may be automatically changed according to the recognized region or country. Accordingly, when the region and country including the present position is changed, it is possible to improve convenience for the user without changing the various settings.

The portable device 10 is detachable from the in-vehicle device 100 by operating the detachment button 201. However, when the detachment button 201 of the portable device 10 is operated, the front unit 200 of the in-vehicle device 100 may be tilted (inclined and moved) with the portable device 10 in a horizontal state and then the lock mechanism for fixing the portable device 10 to the front unit 200 may be released. Accordingly, when the lock mechanism is released, it is possible to prevent the portable device 1O from dropped.

When the portable device 10 is detached, the portable device 10 may be used as a remote controller of the in-vehicle device 100 using the operation unit 18. Accordingly, the operability of the in-vehicle device 100 is improved for the user in the back seat of the vehicle.

What is claimed is:

1. A portable device which is mountable on an in-vehicle device,
wherein the portable device has a plurality of modes;
wherein the portable device includes a control unit which is configured to automatically select one mode from among the modes when the portable device is mounted on the in-vehicle device; and
wherein the one mode to be automatically selected by the control unit is user-presettable.

2. The portable device according to claim 1, further includes an acquiring unit which is configured to acquire information from the in-vehicle device,
wherein the one mode to be automatically selected by the control unit is determined based on the information acquired by the acquiring unit.

3. The portable device according to claim 2, wherein the one mode to be automatically selected by the control unit is determined by a combination of a mode of the portable device, which has been selected before the portable device is mounted on the in-vehicle device and the information acquired by the acquiring unit.

4. The portable device according to claim 1, further includes a display unit and an operation unit,
wherein the one mode to be automatically selected by the control unit is user-presettable by use of the display unit and the operation unit.

5. The portable device according to claim 1, wherein the modes includes at least a navigation mode for performing a navigation function and an audio mode for reproducing audio data.

6. The portable device according to claim 5,
wherein the navigation mode includes a first navigation mode for displaying a map on a display unit with performing a route guide and a second navigation mode for displaying the map on the display unit without performing the route guide; and
wherein the audio mode includes a first audio mode for reproducing only the audio data and a second audio mode for reproducing both the audio data and visual data.

7. A portable device which is mountable on an in-vehicle device,
wherein the portable device has a plurality of modes;
wherein the portable device includes a control unit which is configured to automatically select one mode from among the modes when the portable device is detached from the in-vehicle device; and
wherein the one mode to be automatically selected by the control unit is user-presettable.

8. An electronic device system, comprising:
an in-vehicle device having a plurality of first modes;
a portable device having a plurality of second modes; and
a control unit which is configured to automatically select one mode from among the first modes and the second modes when the portable device is mounted on the in-vehicle device,
wherein the one mode to be automatically selected by the control unit is user-presettable.
